(19) United States
(12) Patent Application Publication
(10) Pub. No.: US 2010/0057565 A1
(43) Pub. Date: Mar. 4, 2010

(54) Systems and Methods for a Graphical Personal Assistant with Context-Sensitive Advertising

(75) Inventors: Patrick AU-YEUNG, San Francisco, CA (US); Aaron GRECO, Belmont, CA (US); Garry TAN, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 12/477,864

(22) Filed: Jun. 3, 2009

Related U.S. Application Data
(60) Provisional application No. 61/058,549, filed on Jun. 3, 2008.

(51) Int. Cl. G06Q 30/00; G06F 3/048

(52) U.S. Cl. 705/14.53; 705/14.55; 705/14.72; 715/780; 715/810; 715/769

(57) ABSTRACT

A system and method provides an advertiser access to a plurality of utilities that allow users to electronically manage trip items in a trip itinerary. An interactive tool allows the advertiser to create an advertisement related to the trip items. An identification of utilities in the plurality of utilities in which the advertisement will appear is received from the advertiser. The advertisement is inserted in the identified utilities.

### CROSS REFERENCE TO RELATED APPLICATIONS

The present application claims priority to provisional U.S. Patent Application Ser. No. 61/058,549, filed on Jun. 3, 2008 and entitled “Graphical Personal Assistant”, the disclosure of which is hereby incorporated herein by reference.

### FIELD OF THE INVENTION

The present application relates to event management and, in particular, systems and methods for a graphical personal assistant with context-sensitive advertising.

### BACKGROUND

Many different solutions have become available to travelers over the last decade that allow them to book trips by means of tools based on the Internet, also commonly referred to as the World Wide Web, although technically the “Web” is only a subset of the Internet. Most of these tools allow for a simple, mostly textual interface, but limit options. For example, in a first step, the flight to a destination is chosen. Then based on the choice, only a limited selection of return flights is offered. In other cases, a set of round trips may be offered, but often not the combination desired by the traveler. Even though flights may exist, the bundling desired by the traveler may simply exceed the scope of the offered flight selection.

### SUMMARY

In one embodiment, a system and method provides an advertiser access to a plurality of utilities that allow users to electronically manage trip items in a trip itinerary. An interactive tool allows the advertiser to create an advertisement related to the trip items. An identification of utilities in the plurality of utilities in which the advertisement will appear is received from the advertiser. The advertisement is inserted in the identified utilities.

Many other features and embodiments of the present invention will be apparent from the accompanying drawings and from the following detailed description.

### BRIEF DESCRIPTION OF THE DRAWINGS

The present disclosure is illustrated by way of example and not limited in the figures of the accompanying drawings in which like references indicate similar elements.

FIG. 1 illustrates an overview of a system in accordance with one embodiment of the present invention.

FIG. 2 illustrates an exemplary screen of a personal assistant tool in accordance with one embodiment of the present invention.

FIG. 3 illustrates an exemplary screen of a personal assistant tool in accordance with one embodiment of the present invention.

FIG. 4 illustrates an exemplary screen of a personal assistant tool in accordance with one embodiment of the present invention.

FIG. 5 illustrates an exemplary screen of a personal assistant tool in accordance with one embodiment of the present invention.

FIG. 6 illustrates an exemplary screen of a personal assistant tool in accordance with one embodiment of the present invention.

FIG. 7 illustrates an exemplary screen of a personal assistant tool in accordance with one embodiment of the present invention.

FIG. 8 illustrates an exemplary dialog box of a personal assistant tool in accordance with one embodiment of the present invention.

FIG. 9 illustrates an exemplary dialog box of a personal assistant tool in accordance with one embodiment of the present invention.

FIG. 10 illustrates an exemplary screen of a personal assistant tool in accordance with one embodiment of the present invention.

FIG. 11 illustrates an exemplary screen of a personal assistant tool in accordance with one embodiment of the present invention.

FIG. 12 illustrates an exemplary screen of a network merchant tool in accordance with one embodiment of the present invention.

FIG. 13 illustrates an exemplary screen of a network merchant tool in accordance with one embodiment of the present invention.

FIG. 14 illustrates an exemplary screen of a network merchant tool in accordance with one embodiment of the present invention.

FIG. 15 illustrates an exemplary screen of a network merchant tool in accordance with one embodiment of the present invention.

FIG. 16 illustrates an overview of client-server architecture in accordance with one embodiment of the present invention.

FIG. 17 illustrates an architecture stack in accordance with one embodiment of the present invention.

FIG. 18 is a flow chart in accordance with one embodiment of the present invention.

Many other features and embodiments of the present invention will be apparent from the accompanying drawings and from the following detailed description.

### DETAILED DESCRIPTION

In the following description, for purposes of explanation, numerous specific details are set forth in order to provide a thorough understanding of the description. It will be apparent, however, to one skilled in the art that embodiments of the disclosure can be practiced without these specific details. In some instances, structures and devices are shown in block diagram form in order to avoid obscuring the description. In other instances, functional block diagrams are shown to represent data and logic flows.

Reference in this specification to “one embodiment,” “an embodiment,” “other embodiments,” or the like means that a particular feature, structure, or characteristic described in connection with the embodiment is included in at least one embodiment of the disclosure. The appearances of, for example, the phrase “in one embodiment” in various places in the specification are not necessarily all referring to the same embodiment, nor are separate or alternative embodiments mutually exclusive of other embodiments.

Moreover, whether or not there is express reference to an “embodiment” or the like, various features are described which may be variously combined and included in some embodiments but also variously omitted in other embodiments. Similarly, various requirements are described which may be requirements for some embodiments but not other embodiments.

The present invention is a novel, graphical interactive method and system for users to plan, schedule, track, and execute details of personal and business events, such as trips, with context-sensitive advertising. The present invention allows simple graphical tools to be employed to let a user select which elements he or she wants in a particular trip, rather than just indiscriminately offering bundles. In some embodiments of the present invention, changes in the symbols, colors, or other indicators may signify preferred or desired bundles, providers, contractors, etc.

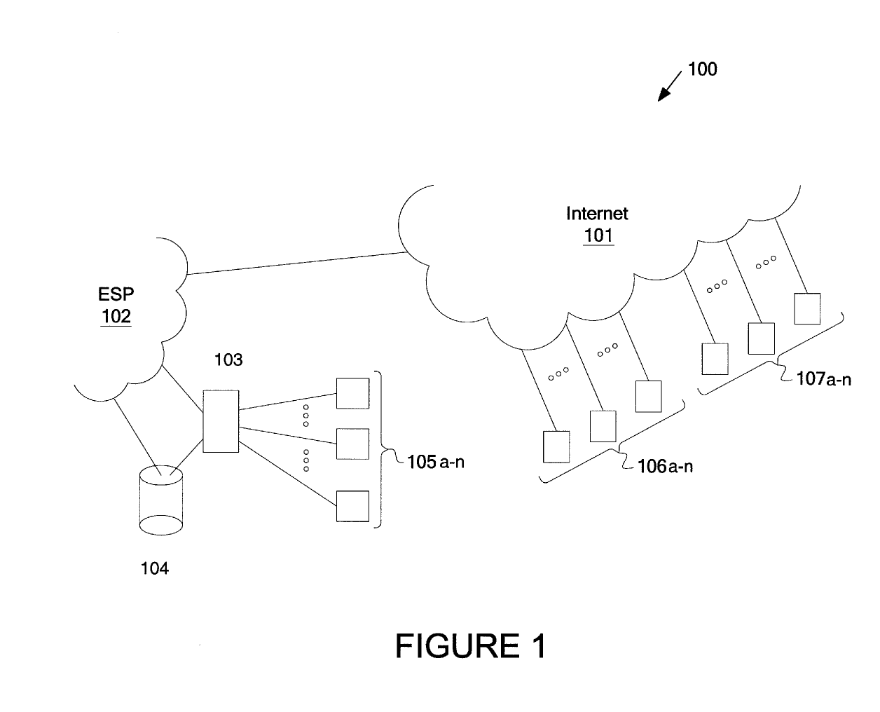

FIG. 1 shows an overview of a system 100 in which a graphical interactive personal assistant tool can be implemented in accordance with one embodiment of the present invention. The system 100 includes an electronic services portal (ESP) 102 that connects to a server 103 and a main data repository 104. The server 103 hosts software instances 105a-n, which, depending on the implementation of the system 100, may be one, several, or many instances. Each instance represents at least a portion of the software used to implement the present invention. The software instances can be installed in the server 103 and can work in conjunction with the ESP 102, personal information managers (PIMs) (not shown), and the main data repository 104. The ESP 102 connects via Internet 101 to computing devices 106a-n of system users and computing devices 107a-n of suppliers. It is clear that these connections could also be through direct connection, through a phone system, or through any other suitable networking method, known or later developed.

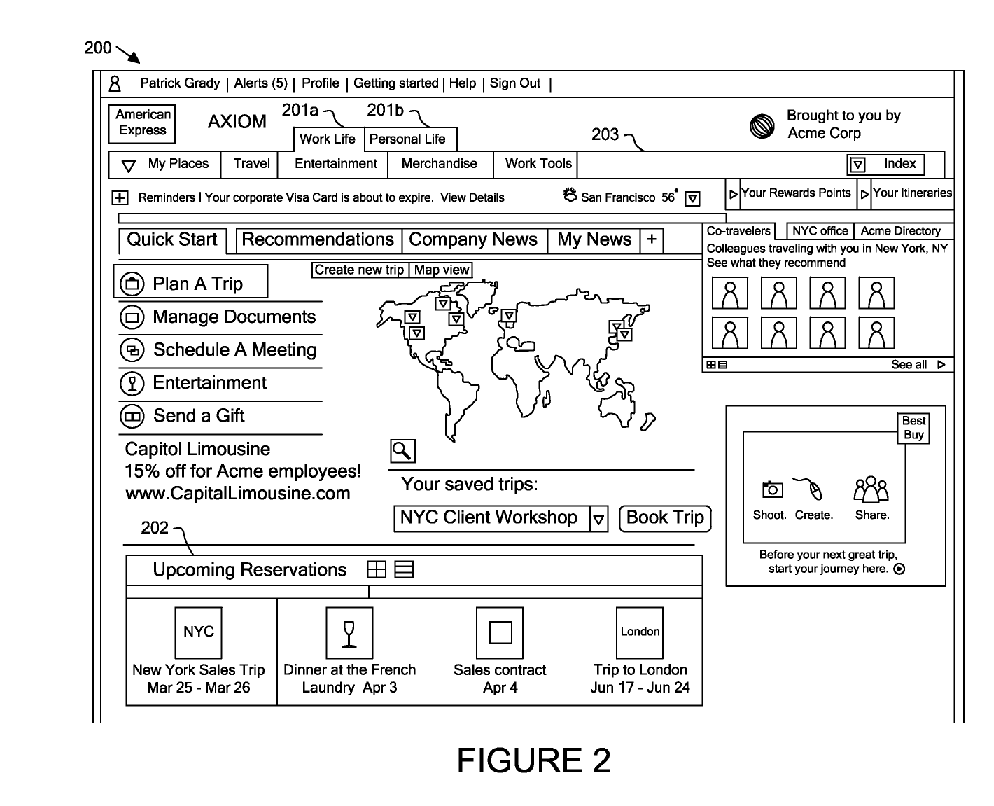

FIG. 2 shows an exemplary screen 200 of the graphical interactive personal assistant tool according to one embodiment of the present invention. The screen 200 includes a “Work Life” tab 201a, a “Personal Life” tab 201b, an area 202, labeled “Upcoming Reservations,” and a menu bar 203. The Work Life tab 201a and the Personal Life tab 201b represent different domains of the user's life and correspond to, as their names imply, the work life domain and the personal life domain of the user. A user may select the Work Life tab 201a or the Personal Life tab 201b for events and services pertaining to, respectively, his business life or his personal life. In one embodiment, the user can create his own custom tabs (not shown) in addition to or in place of the Work Life tab 201a and the Personal Life tab 201b.

Each tab selection changes various areas of the screen 200 so that context-appropriate information and links appear, as well as context-sensitive advertisements. At the bottom of the screen 200 is the area 202 that is labeled “Upcoming Reservations.” The Upcoming Reservations area 202 shows future reservations of the user, as discussed in more detail below.

The user can click on any of the topics on the menu bar 203 to open windows with options appropriate to the topic. As shown for the Work Life tab 201a, the menu bar 203 includes the topics “My Places,” “Travel,” “Entertainment,” “Merchandise,” and “Work Tools.” In one embodiment, other topics can be included in the menu bar 203.

For example, if the user, who has already clicked on the Work Life tab, subsequently clicks on the Travel topic in the menu bar 203, a window opens with links to many travel-related services, such as, for example, flight, hotel, rental car, corporate shuttle, charter flights, luggage forwarding, medical evacuation, security alerts, currency conversion, etc. Depending on whether the user selects the Work Life tab 201a or the Personal Life tab 201b (or a different tab), he may be offered different choices for the various different personas of each tab.

The user may also click on the My Places topic, in which case a window opens with links to such options as stores and reservations. The stores options allow the user to click on links to different types of services such as trip planning, document services, event tickets, dining, etc. In one embodiment, a window may show a list of recently visited service types.

The user may also click on the Work Tools topic, in which case a window opens with links to various work-related applications. If the user clicks on one of the applications, the application opens within the screen 200 of the personal assistant tool.

In one embodiment, screens, such as the screen 200 and the screens, windows, and boxes discussed below, can be programmed by using highly interactive software platforms and combinations, such as Personal Home Page Hypertext Preprocessor (PHP), Java, JavaScript, Cascading Style Sheets (CSS), Flex by Adobe, etc. Such software platforms and combinations can connect to a back-end system (as shown in FIG. 1). Typically a web server delivers the front end application and connects to the back end via a middleware layer, running on the web server or any other suitably available server, as further discussed below.

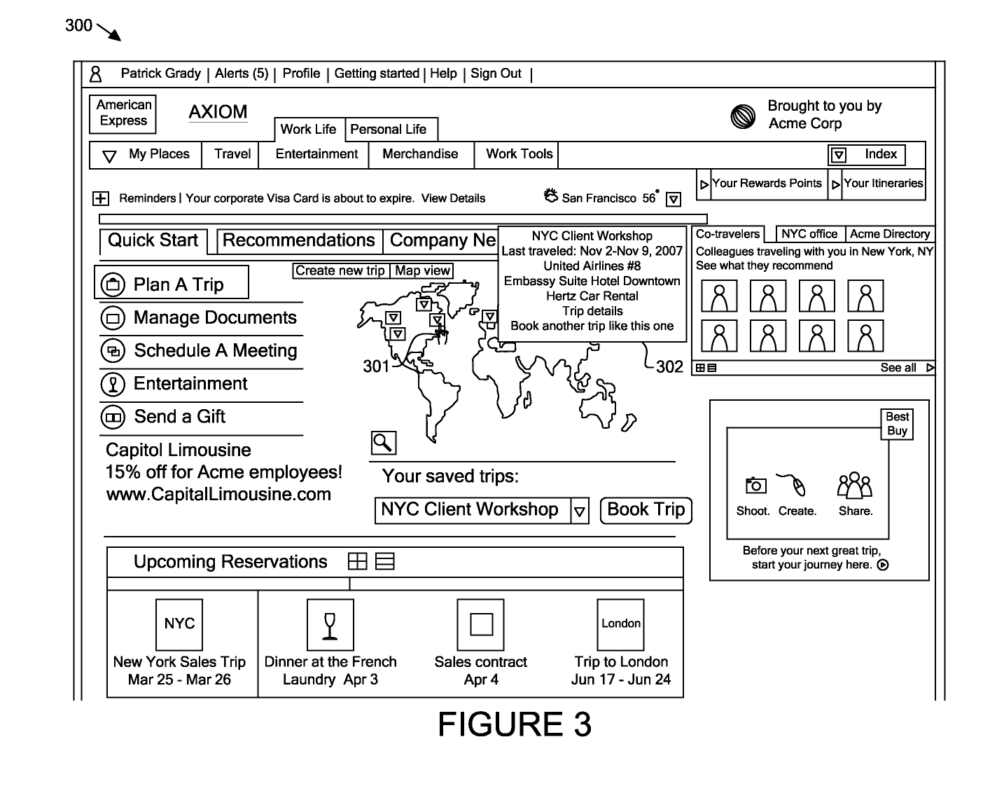

FIG. 3 shows an exemplary screen 300 of the personal assistant tool that appears for a user who is planning a trip. The screen 300 includes a display of selectable previous locations visited by the user, including a previous travel destination 301. When the previous travel destination 301 is clicked on (or otherwise selected) by the user, a pop-up window 302 shows details of the previous trip. As shown in the screen 300, the previous travel destination 301 concerns a previous visit to New York by the user. The pop-up window accordingly displays various information about the visit to New York, including such information as event, date, airline, hotel, and rental car.

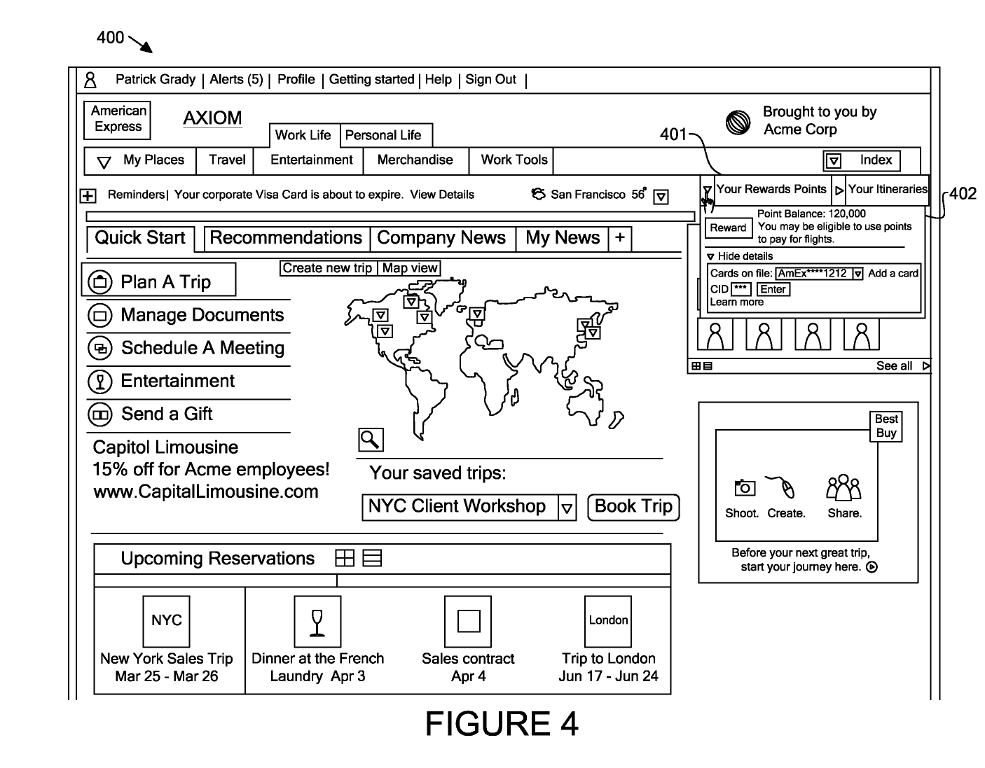

FIG. 4 shows an exemplary screen 400 that appears for a user who wishes to check his frequent flier points or other similar bonus programs to which he may be subscribed. The screen includes a “Your Rewards Points” link 401. When the user clicks on the Your Rewards Points link 401, a pop-up window 402 opens to display details about the rewards program of the user, including, for example, a balance or points or credits for a reward program as well as associated credit card information. In one embodiment, information about multiple reward programs and multiple associated credit cards can be displayed in the pop-up window 402.

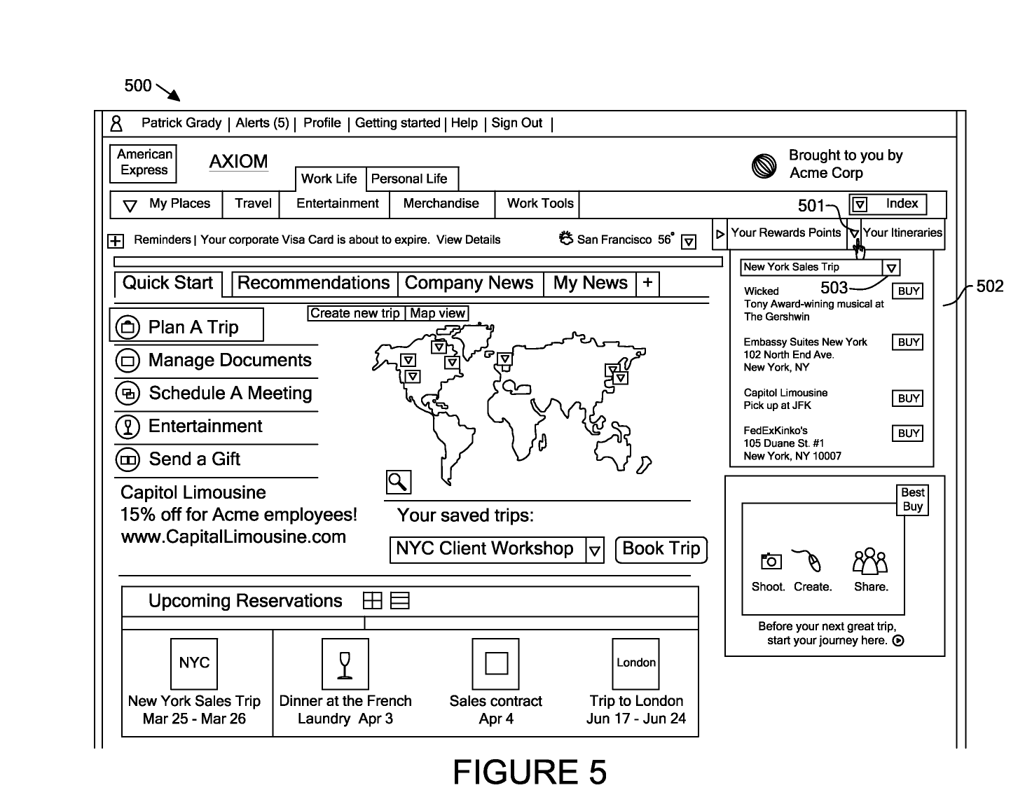

FIG. 5 shows an exemplary screen 500 that appears for a user who wishes to check events and services available for his itinerary. The screen 500 includes a “Your Itineraries” link 501. When the user clicks on the Your Itineraries link 501, a pop-up window 502 opens to display a list from which the user may select one or more desired items related to the particular itinerary selected in a drop down list of itineraries 503 of the user. The screen 500 shows, for example, that a “New York Sales Trip” has been selected by the user in the drop down list of itineraries 503. Accordingly, the pop-up window 502 automatically displays various options that may be desired for the New York Sales Trip of the user, such as attending a musical, hotel accommodations, ground transport, and mail and copying services. In one embodiment, other options can be displayed in the pop-up window 502.

In one embodiment, the drop down list of itineraries 503 will include multiple itineraries. The selection by the user of a particular itinerary in the drop down list of itineraries 503 will display a tailored set of options that are related to the particular itinerary.

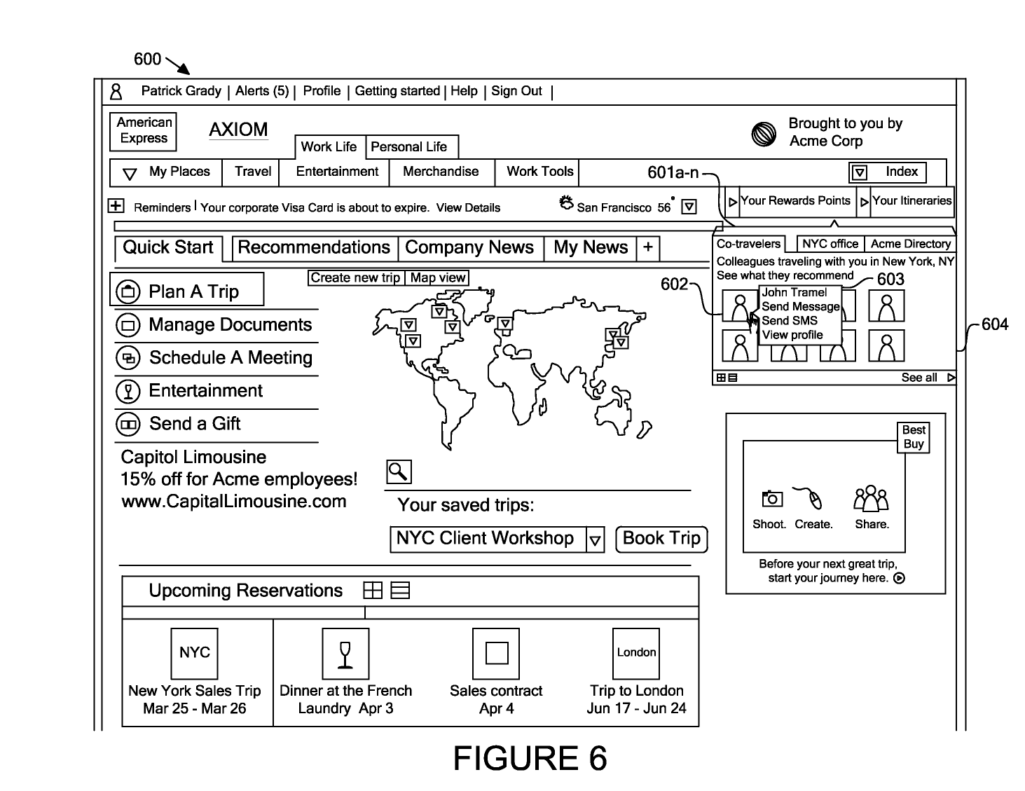

FIG. 6 shows an exemplary screen 600 that displays various persons related to an event selected by the user. The screen 600 includes a “Co-travelers” tab, an “NYC Office” tab, and an “ACME Directory” tab, collectively referenced in FIG. 6 as 601a-n. The user may select the Co-travelers tab, the NYC Office tab, and the ACME Directory tab to, respectively, view co-travelers on a selected trip, personnel in a selected office, or a particular address list. For example, when the user clicks on the Co-traveler's tab, various people who are traveling with the user on a particular trip are displayed in selectable boxes in a window 604 of the screen 600. In one embodiment, each of the boxes corresponds to a person. The window 604 includes a box 602 that corresponds to a particular person, which has been selected by the user. The selection of the box 602 opens a box 603 containing details about the person and contact information.

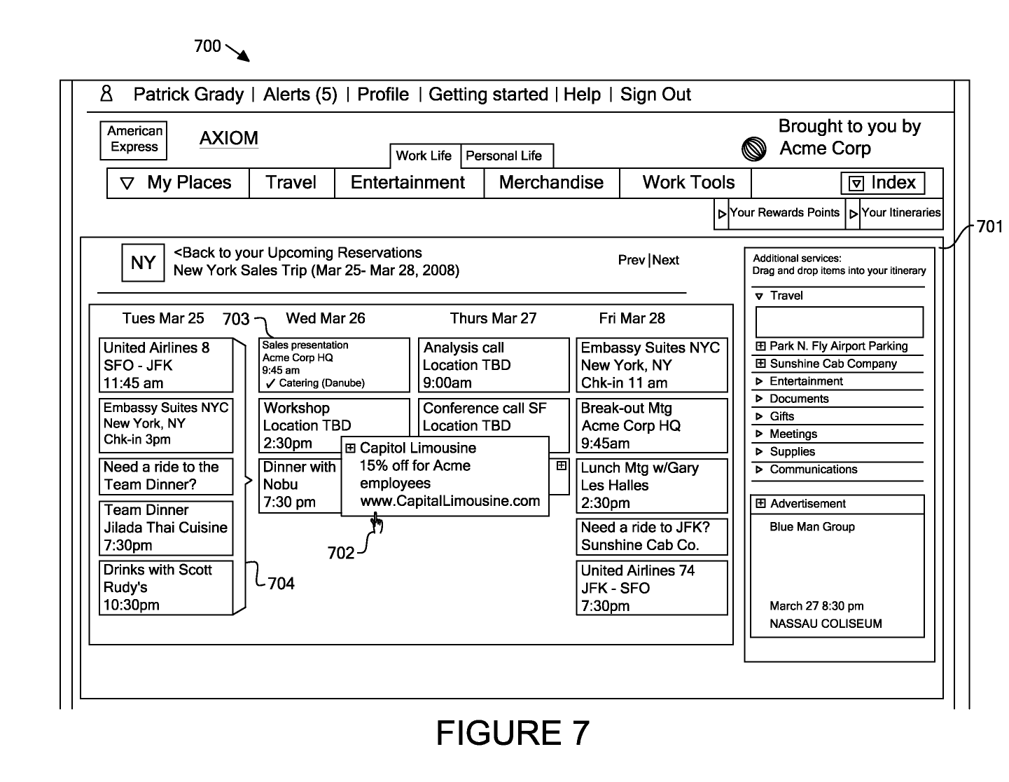

FIG. 7 shows an exemplary screen 700 that opens when the user clicks on a “New York Sales Trip” item in the Upcoming Reservations area 202 of the screen 200 shown in FIG. 2. When the user clicks on the New York Sales Trip item for a multi-day business trip to New York, the screen 700 displays details of the user's trip itinerary in an itinerary area 704. The itinerary includes various items that together constitute his itinerary for a given period of time. In one embodiment, the various items of the itinerary are organized chronologically. The user can select from a services listing 701 at the right side of the screen 700. The services listing 701 includes various categories of services such as travel, entertainment, documents, gifts, meetings, supplies, and communications. In one embodiment, other categories of services can be listed in the services listing 701. Each category of listed services can include various service providers and associated services offered by the service providers that can be selected by the user. The services listing 701 can also include, for example, coupons and other information about various services.

When the user identifies a desired service in the services listing 701 for his itinerary, the user can select the service by appropriately “dragging and dropping” the selected service into the itinerary area 704, as needed. For example, as shown in FIG. 7, the user needs a ride from one event to another, so he pulls a limousine service coupon 702 from the services listing 701, and drags and then drops it between a point of origin (i.e., the item “Workshop” at 2:30 pm) and his destination (i.e., the item “Dinner” at 7:30 pm) in the itinerary. In one embodiment, a confirmation box (not shown) opens in front of the screen 700, where the user can check and, if needed, edit details of the service, such as, for example, the time, date or place of pick up and drop off. When the user confirms the service details, the service then appears in the itinerary. Likewise, for example, when selecting a hotel item for the itinerary, the user may confirm his hotel stay in a confirmation box that opens in front of the screen 700.

The user can order additional services, such as, for example, services related to the item “Sales Presentation” 703.

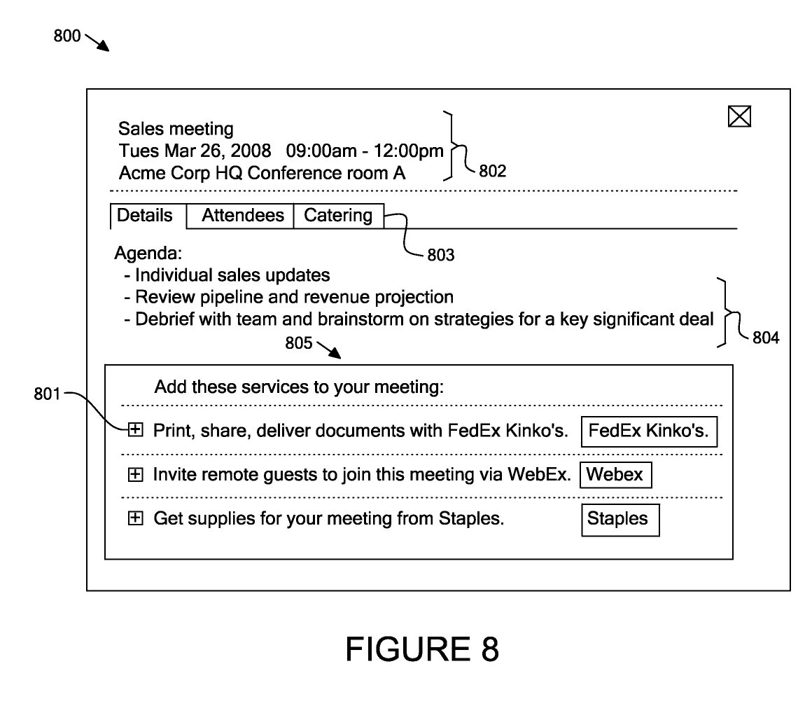

FIG. 8 shows an exemplary dialog box 800 that opens when a user clicks the item “Sales Presentation” 703 in the itinerary shown in FIG. 7. As its name implies, the item “Sales Presentation” 703 corresponds to a meeting schedule during the trip of the user. The user may need to order document services for the meeting. The dialog box 800 includes various fields of information about the meeting such as profile information 802, tabs 803, a tab description 804, and additional services 805. The profile information 802 includes a summary description of the date, time, and location of the meeting. The tabs 803 correspond to a “Details” tab, an “Attendees” tab, and a “Catering” tab. In one embodiment, other tabs can be included in the dialog box 800. As shown in FIG. 8, the Details tab has been selected. The selection of the Details tab displays corresponding agenda information in the tab description.

The user can choose from various items in the additional services 805 to be performed for the meeting. The additional services 805 can include document services, remote guest invitation services, and supply services. In one embodiment, other services can be included in the additional services 805. By selecting, for example, selection 801 of the additional services 805, the user can request document services from a copy shop.

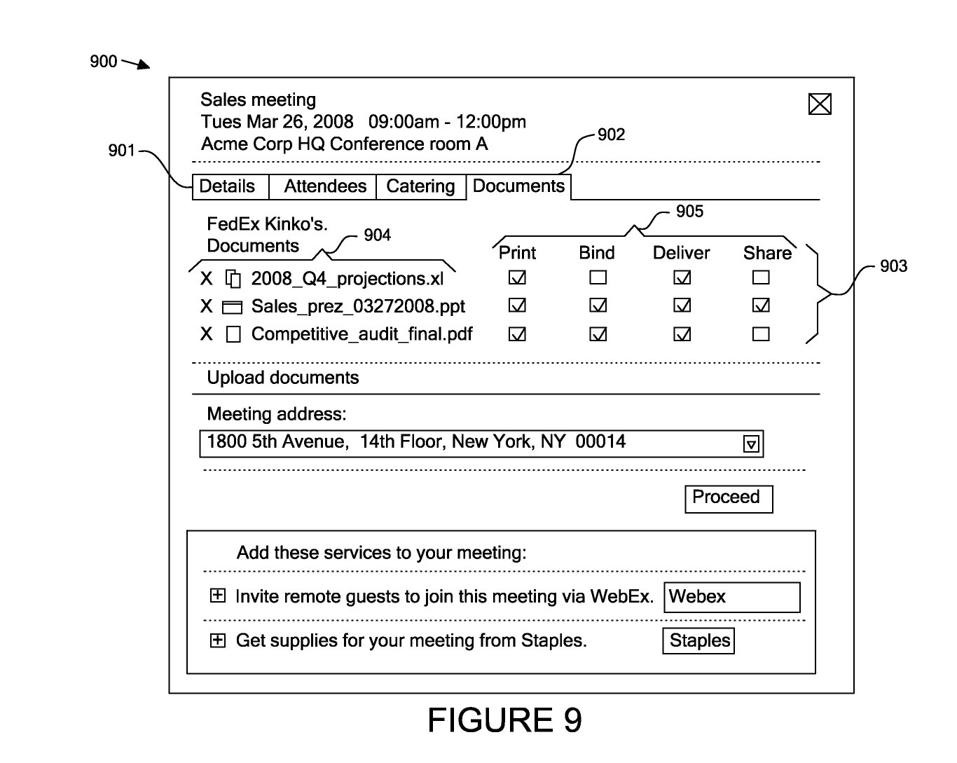

FIG. 9 shows an exemplary dialog box 900 that can be supplied by a document services vendor after the user requests copy shop services by clicking on the selection 801. The dialog box 900 includes tabs 901. In one embodiment, some of the tabs 901 correspond to the additional services 805 that have been selected by the user. As shown in FIG. 9, the dialog box 900 includes a “Documents” tab 902 that has been automatically added to the dialog box 900 as a result of the user choosing selection 801. The dialog box 900 includes a documents information field 903 having a documents upload field 904 and document handling options 905. The document upload field 904 allows the user to upload documents for handling by the document services vendor. The document handling options 905 allow the user to indicate how the uploaded documents should be handled. By appropriate selection of the document handling options 905, the user can choose to print and copy, bind, deliver, and/or share the uploaded documents in connection with the meeting.

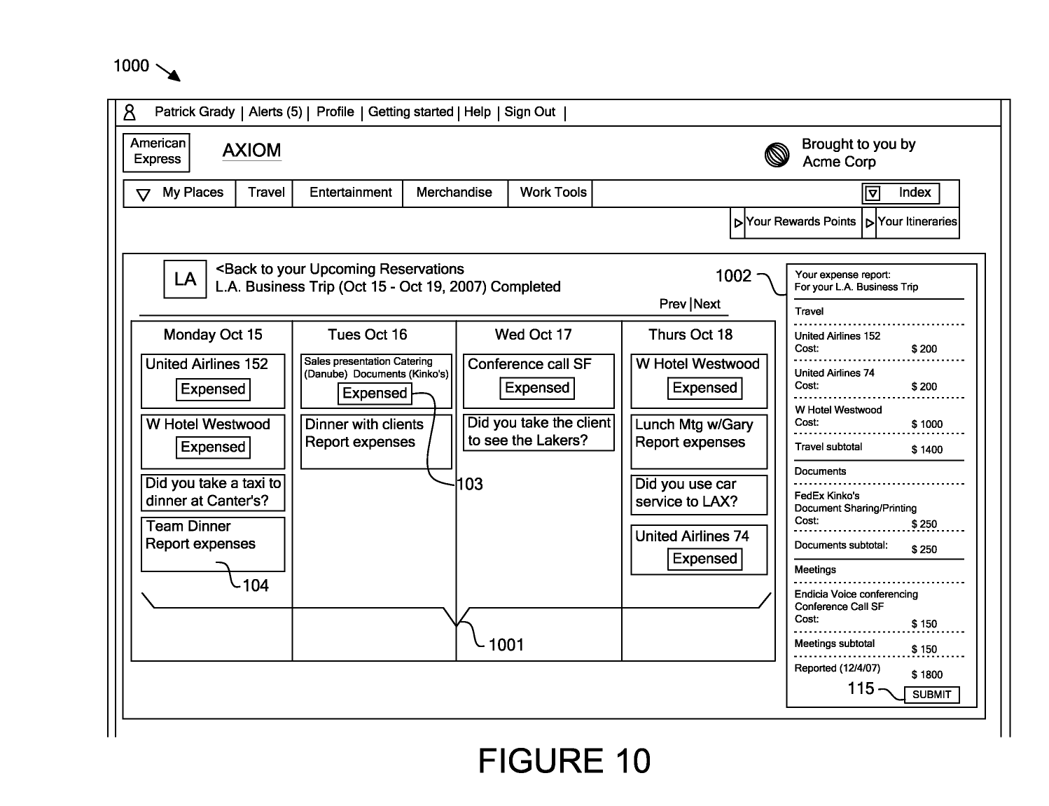

FIG. 10 shows an exemplary screen 1000 that opens for an already-completed item “L.A. Business Trip (Oct. 15-Oct. 19, 2007) Completed.” The screen 1000 allows a user to categorize expenses for a trip and manage reimbursements of various expense items. The screen 1000 displays details of the user's trip itinerary in an itinerary area 1001. The itinerary area 1001 includes various items that together constitute his itinerary for a given period of time. In one embodiment, the various items of the itinerary are organized chronologically. When an item has already been reimbursed as an expense, an expensed indication 103 is included in the item. When an item has not been expensed, a report expense indication 104 can be included in the item to signify that the user should expense the item. In one embodiment, a button (not shown) adjacent to each expense item, when selected, can allow the user to assign the expense item to a particular trip and/or a particular account. Then, the expense item automatically can be included in an expense report when a trip is completed.

The screen 1000 includes an expense report 1002 that lists various expense items associated with the trip in different expense categories. The expense categories shown in the expense report 1002 include travel, documents, and meetings. In one embodiment, other expense categories can be included in the expense report 1002. Each expense category lists the expense items within the category and provides a subtotal for the category. The expense report 1002 includes a total of all expense items. The expense report 1002 can be submitted upon selection of a submit button 105.

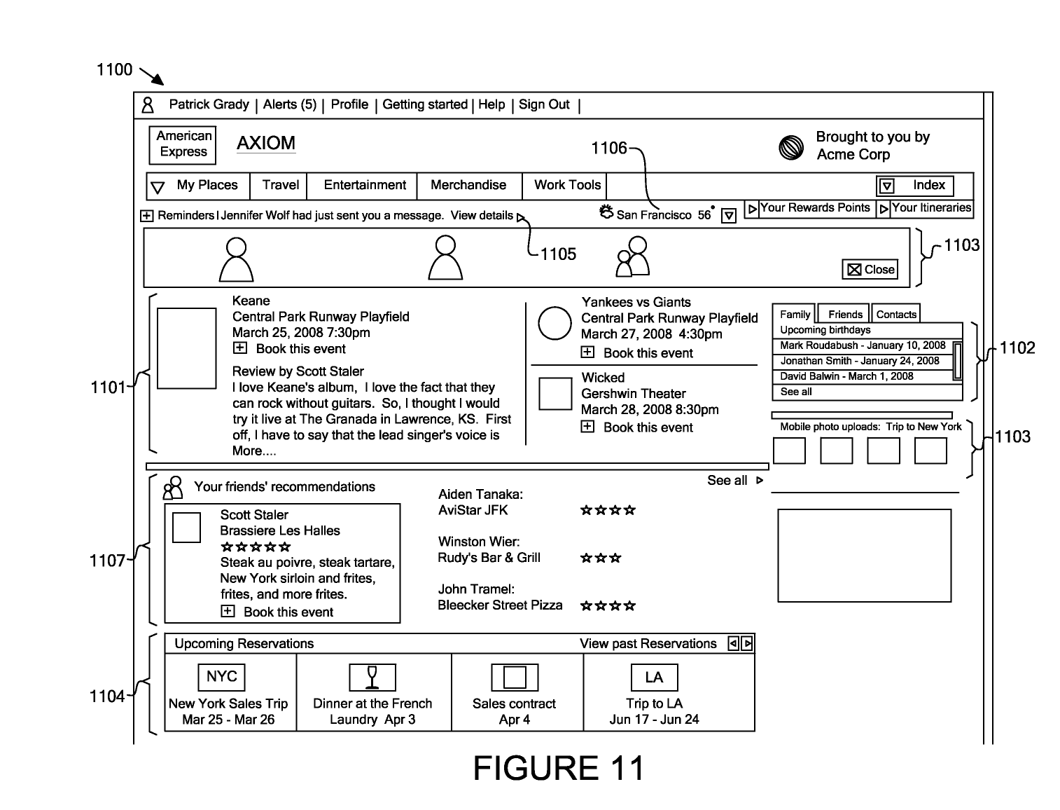

FIG. 11 shows an exemplary screen 1100 that appears upon selection by the user of the Personal Life tab 201b. The screen 1100 includes an event listing area 1101, an upcoming birthdays area 1102, photo areas 1103, an upcoming reservations area 1104, message notices 1105, weather data 1106, and recommendations from friends area 1107 including links of service providers with contact information. The event listing area 1101 includes a listing of events that may be desirable to the user, along with date, time, and location information. The birthdays area 1102 contains birthday information of persons known to the user. The photo areas 1103 allows the user to display photos of interest. The upcoming reservations area 1104 includes reservation information about future events of the user. The message notices 1105 provide an indication to the user of messages sent by others to the user. The weather data 1106 is current weather information at a location of the user. The recommendations from friends area 1107 includes restaurants and other business establishments that have been recommended to the user as well as rating information and contact information for the restaurants and the business establishments. In one embodiment, each of the various items in the areas of the screen 1100 can be selected by the user to, in turn, display additional information about the item. In one embodiment, the screen 1100 can contain other information that would be desirable to display and manage for the user.

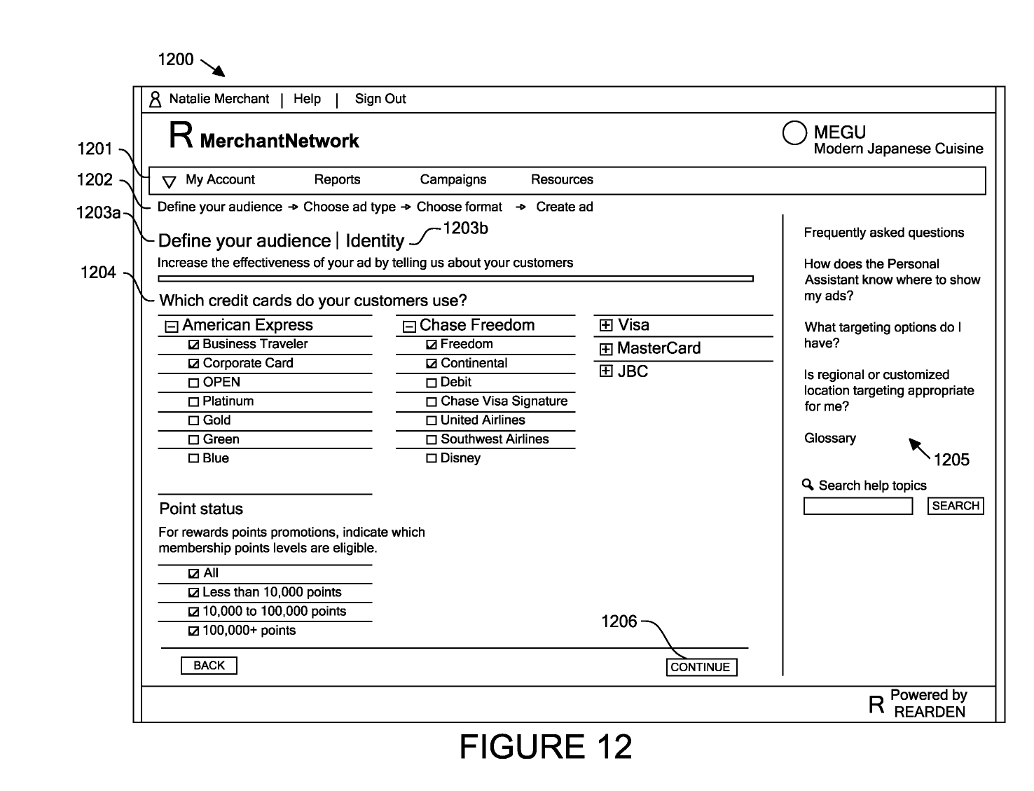

FIG. 12 shows an exemplary screen 1200 of a network merchant tool in accordance with the present invention that allows advertisers (who may be partners of a merchant network) to develop context-sensitive advertisements through a series of interactive screens. A user of the network merchant tool, who may be a participating merchant of the merchant network in the role of an advertiser, proceeds through a series of steps (or stages) to identify and target viewers based on desired demographic classifications. At the top of the screen 1200 is a menu bar 1201 with tabs listing the various service areas available to advertisers. The menu bar 1201 includes a “My Account” tab, a “Reports” tab, a “Campaigns” tab, and a “Resources” tab. When selected, the My Account tab provides information about the account of the user. When selected, the Reports tab provides information to the user about the account, advertisements, etc. in the form of reports. The Campaigns tab, when selected, provides information to the user about advertisement campaigns that have been run or may be run in the future. The Resources tab, when selected, provides the user with sources of information that may be of interest or desirable to the user in the use of the network merchant tool. In one embodiment, other tabs can be included in the menu bar 1201.

Below the menu bar 1201 is a progress bar 1202. The progress bar 1202 indicates to the user the current location within the various stages of advertisement development. The various stages of advertisement development include defining the advertisement, choosing an advertisement type, choosing a format, and creating the ad. In one embodiment, other stages are possible. Below the progress bar 1202 are the title 1203a and subtitle 1203b of the current development stage.

A main area 1204 of the screen 1200 contains data gathering fields that use check boxes, radio buttons, pull-down menus, and fill-in boxes. On the right side of the screen 1200 is a list 1205 of frequently asked questions and a search function. The frequently asked questions in the list 1205 change according to the data being gathered in each screen.

As shown in FIG. 12, the user takes the first of the four steps, entitled “Define your audience” 1203a with a subtitle “Identify” 1203b. Data collected from the user includes information about customers of the user. The information about customers of the user includes preferred credit cards, customer profile (business title, age, gender, industry, membership programs, etc.), viewer location and travel destinations, advertisement context (personal or business life, service interest of viewer, etc.), reward program eligibility levels, etc. In one embodiment, other customer information can be collected. A button 1206 can be selected to advance to a next stage.

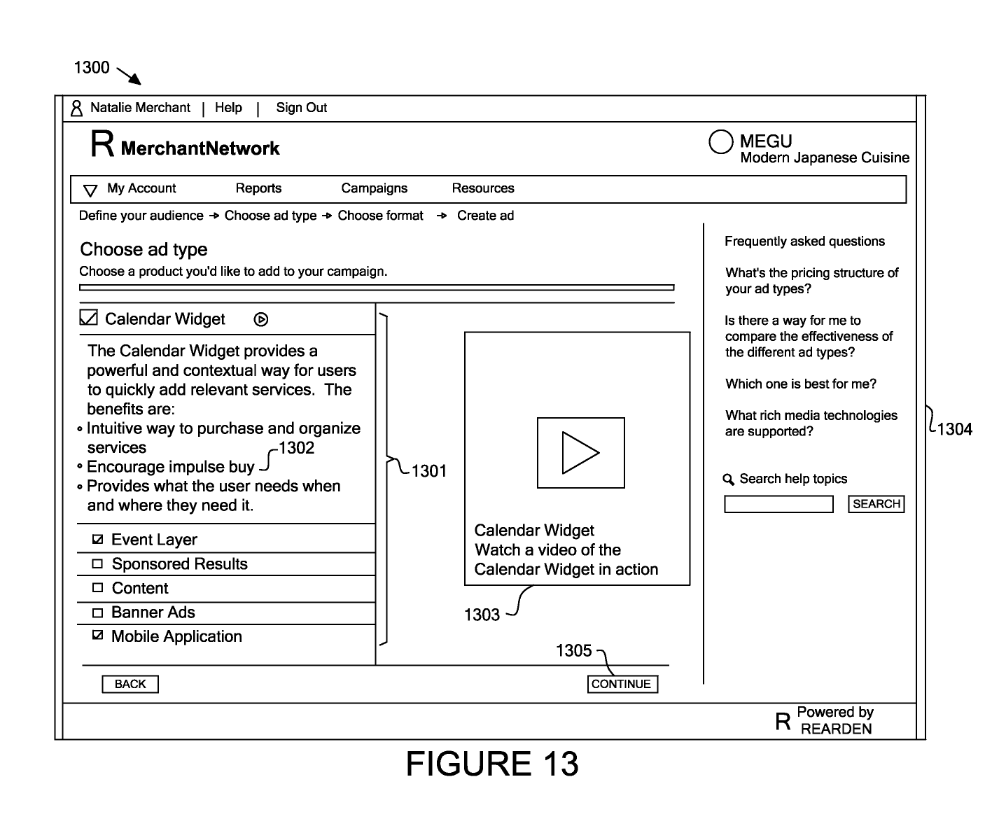

FIG. 13 shows an exemplary screen 1300 of a second step, entitled “Choose ad type,” in the staged development to set up targeted ads. On the left side is toolbar 1301 where the user chooses in which applications the advertisement is to appear. In one embodiment, the applications are utilities that perform a desired function for persons to which advertisements of the user are targeted, such as trip planning, calendar, expense reporting, etc. In one embodiment, the advertisements can selectively appear in other material and content. In this example, the user checked “Calendar Widget,” “Event Layer,” and “Mobile Application” in the toolbar 1301 as the applications in which the advertisement will appear. As the user has highlighted the “Calendar Widget” bar (i.e., the first element of toolbar 1301), it expands an information section 1302 with more detail about the Calendar Widget.

A video 1303 of the Calendar Widget (CW) appears at the center of the screen 1300 for selection and play by the user. The video 1303 can be a general video showing features of the Calendar Widget or a simulation of the Calendar Widget featuring the advertisement therein. In one embodiment, the information section 1302 includes more information about any of the applications listed in the toolbar 1301 that has been selected by the user. In one embodiment, video or other audio-visual content regarding the application selected by the user in the screen 1300 can feature the advertisement or otherwise allow the user to preview the advertisement in its planned context and environment. On the right side of the screen 1300, a help bar area 1304, including frequently asked questions and a search function, is available to the user for self-help. A button 1305 can be selected to advance to a next stage.

In one embodiment, the user can specify the particular portions or screens of a particular application on which the advertisement is to appear to provide context-sensitive display of the advertisement.

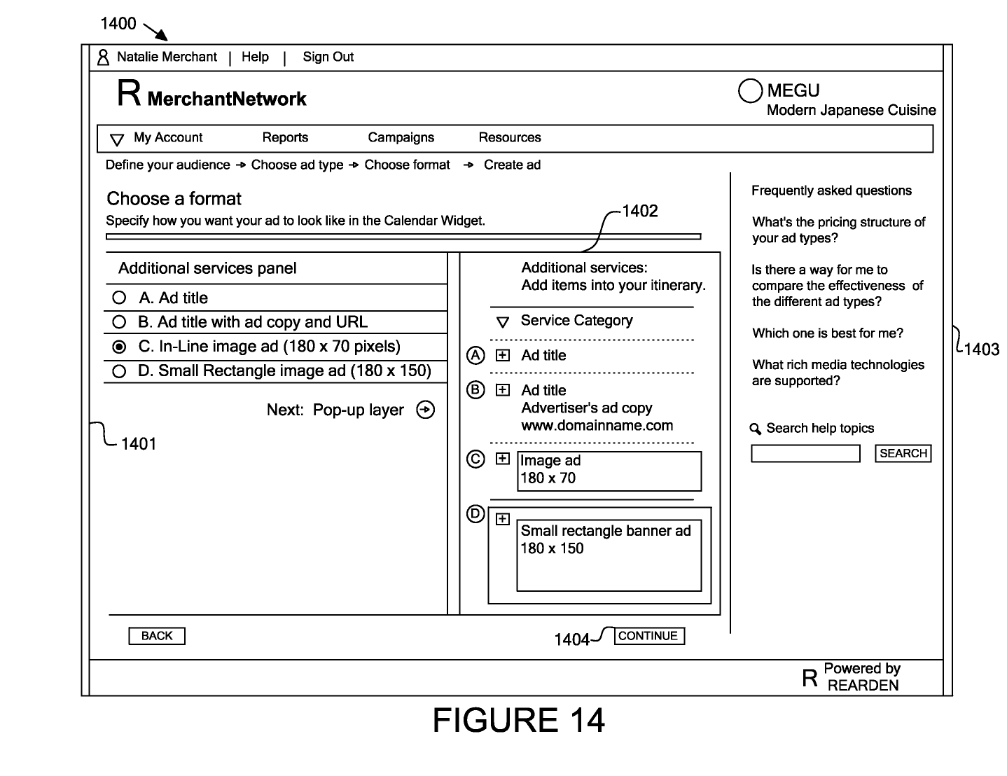

FIG. 14 shows an exemplary screen 1400 of a third step, entitled “Choose a format,” in the staged development to set up targeted ads. The screen 1400 allows the user to select the size and format of the ad by choosing from various ad style options. Panel 1401 shows different ad styles that are available for selection by the user. Dialog box 1402 provides the ad styles of panel 1401 with additional detail and prompts the user to provide information appropriate for each selectable ad style.

In the example shown in FIG. 14, four ad style options are provided. An “Ad title” option, an “Ad title with ad copy and URL” option, an “In-line image ad (180×70 pixels)” option, and a “Small Rectangle image ad (180×150)” option all appear in the panel 1401 and the dialog box 1402. In one embodiment, other ad style options can be included with any number of various formats, sizes, content, graphic resolution, etc. As their names imply, each ad style option prompts the user to provide appropriate information so that the particular requirements of the ad style option can be satisfied.

On the right side of the screen 1400, a help bar area 1403, including frequently asked questions and a search function, is available to the user for self-help. A button 1404 can be selected to advance to a next stage.

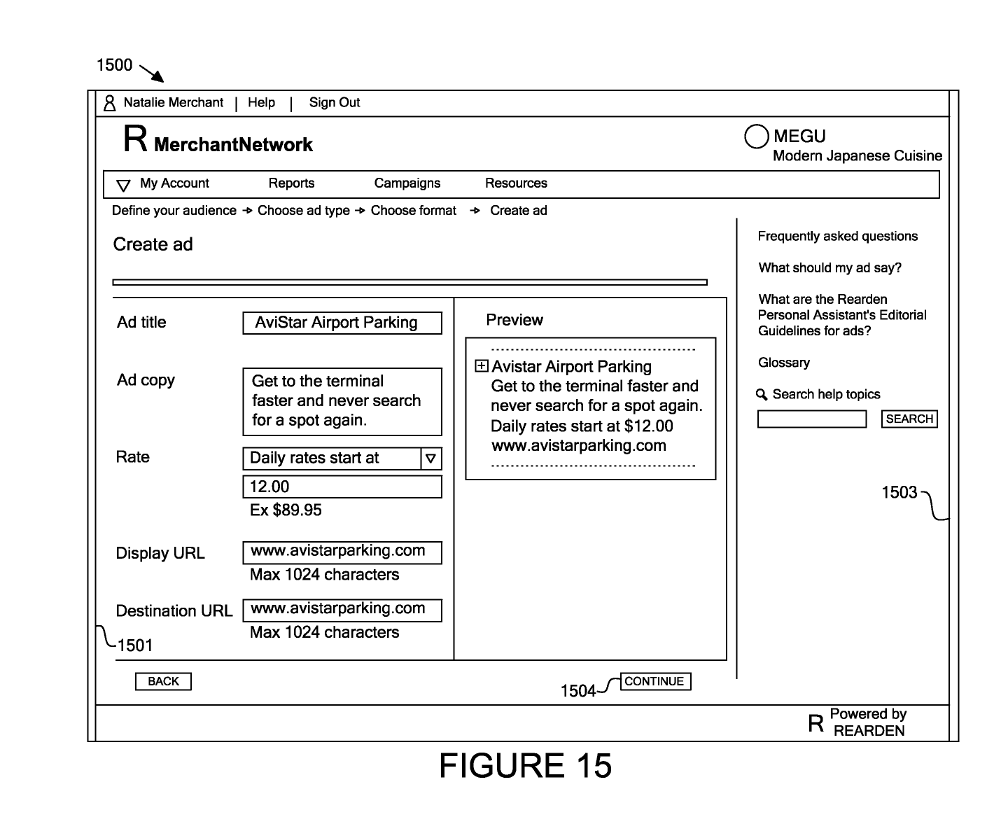

FIG. 15 shows an exemplary screen 1500 of a fourth step, entitled “Create ad,” in the staged development to set up targeted ads. An ad creation panel 1501 includes various fields which prompt the user to provide various information to create the ad. A preview box 1502 displays a simulation of the ad based on the information provided by the user so that the user can preview the ad in a preliminary form before finalization. In the example shown in FIG. 15, the creation panel 1501 includes fields for the user to enter the ad title, the ad copy, rate of the advertised services, a display URL of the user or service provider to display to the reader of the ad, and the destination URL representing the actual web page visited upon selection of the display URL. In one embodiment, the various fields of the creation panel 1501 can prompt the user to enter additional and different information. The preview box 1502 displays the ad with the ad title, the ad copy, rate of the advertised services, and the display URL. On the right side of the screen 1500, a help bar area 1503, including frequently asked questions and a search function, is available to the user for self-help. A button 1504 can be selected when the user has completed the to advance to a next stage.

In one embodiment, the advertisements created in accordance with the present invention are displayed automatically without input or selection by the user.

In one embodiment, the advertisement is displayed in a context-sensitive manner in or adjacent to particular portions (e.g., screens, pages, fields, links, items, etc.) of applications, utilities, etc. related to the goods and services advertised in the advertisement.

In one embodiment, the advertisement is displayed in a context-sensitive manner in applications, utilities, etc. related to the goods and services advertised in the advertisement.

In one embodiment, the personal assistant tool and the network merchant tool are integrated into a single tool in accordance with the present invention.

In one embodiment, the personal assistant tool and the network merchant tool can be implemented separately.

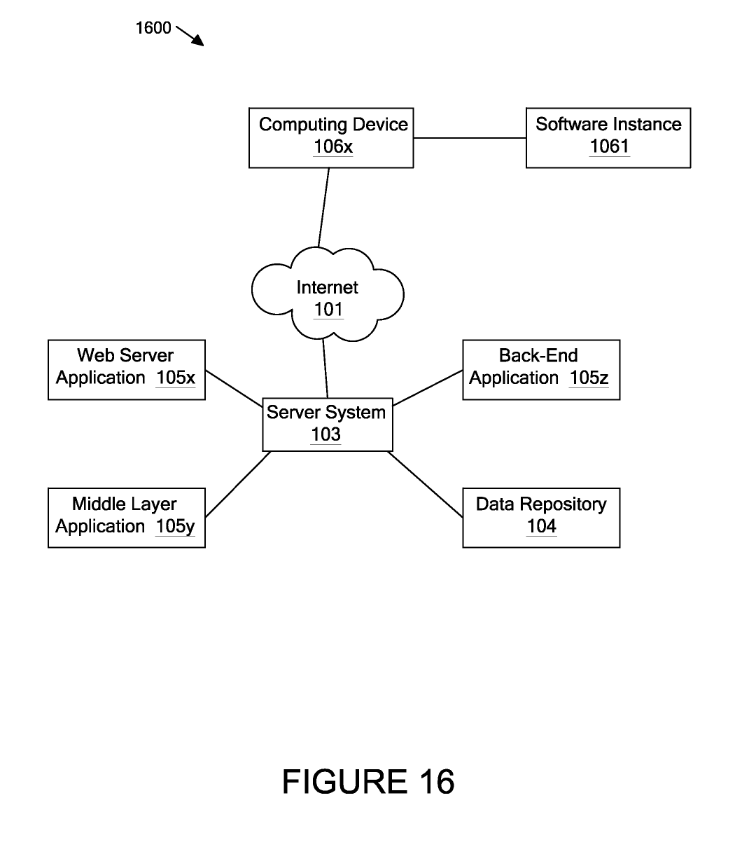

FIG. 16 shows an exemplary overview of client-server architecture 1600 in accordance with the present invention for highly interactive web-based applications. Client device 106x is a computing device. Client device 106x can be a hand-held device, a laptop or desktop computer, a web appliance, or any other of various well known personal computing devices. Client software instance 1601 is executed on device 106x. Typically, in a web environment, client software instance 1601 can be a plug-in to a browser. It may be downloaded in runtime or it may be stored in the device 106x. In some cases it may even be available to do certain functions offline and, when the device 106x again connects to the Web, the client software instance 1601 sends the results. The device 106x typically is connected through Internet 101 to server system 103, and on the server system 103, in this example, web server application 105x is run. The web server application 105x can be, for example, IBM WebSphere, or the public domain Apache web server, or any of various other well-known web server applications.

Also running on server system 103 is a middle layer application 105y, which in this case may be a personal home page (PHP) engine, which is an HTML preprocessor that allows users to perform functions and interface with back-end applications, such as SQL database application 105z, which also runs on the server 103. In some cases, the various components, such as the web server, the PHP, and the SQL server may be separated into different physical servers, while in other cases they may run on the same machine. Also shown is data repository 104, which can be used by web server 106x to serve the client software instance 1601. It is clear that the system shown in this diagram is, for reasons of clarity and simplicity, a simplified exemplary representation of principles of the client-server architecture. In actual cases, there may be many additional components and multiple instances of each. For example, the client software may have a separate procedural program for each screen and for each pop-up, or it may be all in one application.

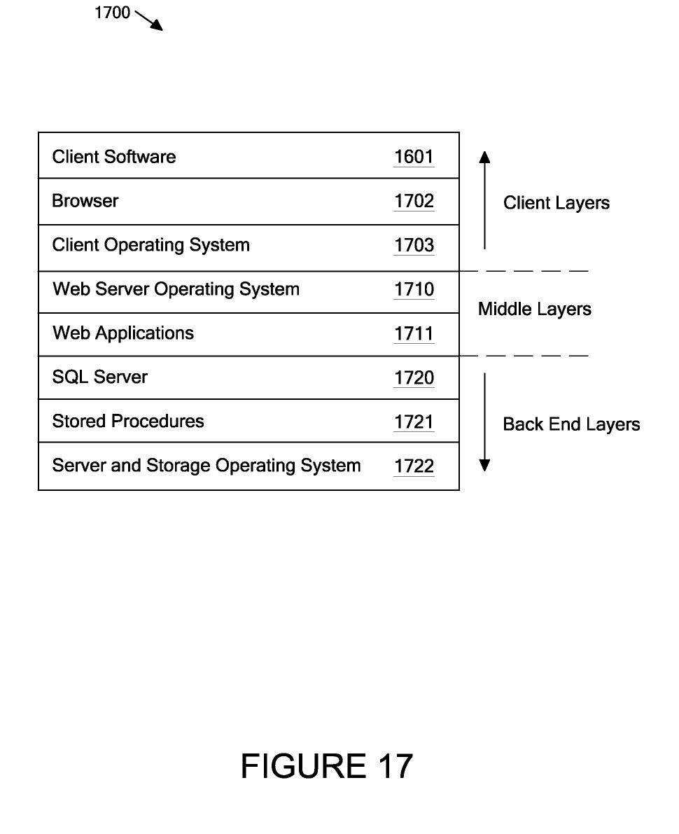

FIG. 17 shows an overview of a stack 1700, which is an alternate view of the exemplary system described above in the discussion of FIG. 16. The stack 1700 has client layers, middle layers, and back end layers. The three layers of the client stack are client software 1601, a browser 1702 (which is inherently present in FIG. 16, but is not explicitly shown), and an underlying client operating system, BIOS, etc. 1703, which are necessary to run the browser 1702. This layered approach is the reason that device 106x may be any kind of computing device. In this regard, by making client software 1601 a plug-in to a browser, any device that has a working browser may be used as a client. Web server operating system 1710 in the middle layer uses its serving capabilities to serve web applications 1711 and also serve the client software to the client. In the back end, SQL server 1720 uses stored procedures 1721 to operate a server and storage OS 1722. Typically many SQL software systems are available commercially or for free, and other types of suitable databases may be used in lieu of an SQL system.

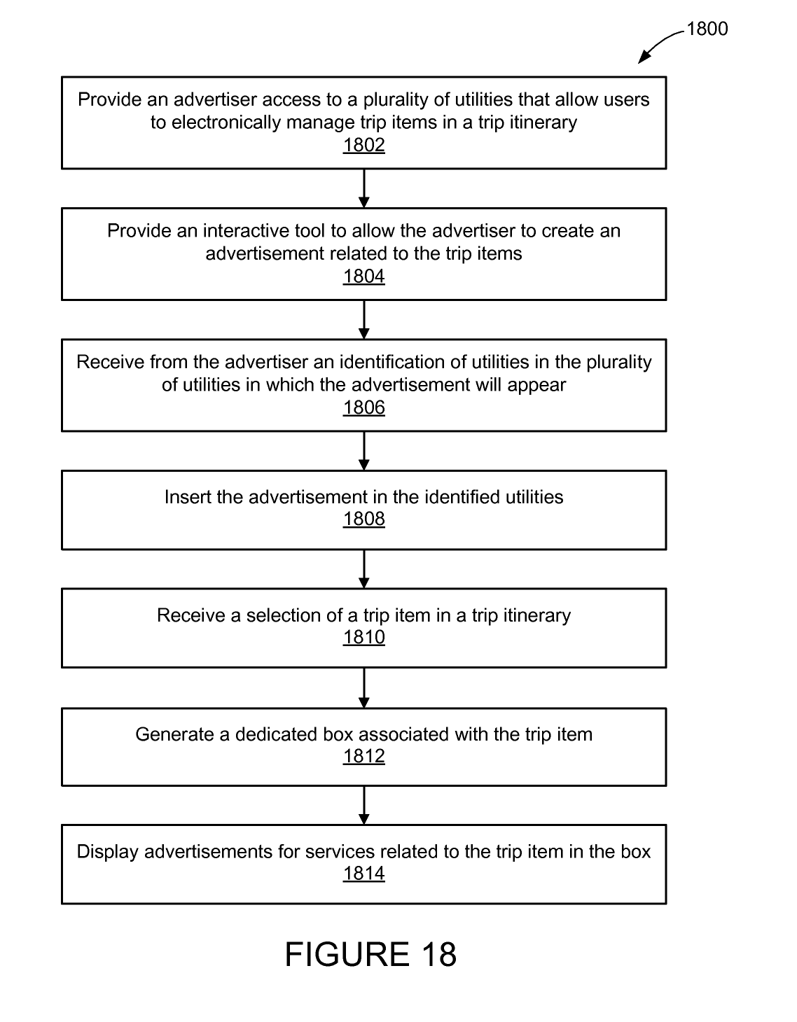

FIG. 18 is an exemplary flow chart of a routine 1800 in accordance with one embodiment of the present invention. At step 1802, an advertiser is provided access to a plurality of utilities that allow users to electronically manage trip items in a trip itinerary. At step 1804, an interactive tool is provided to allow the advertiser to create an advertisement related to the trip items. At step 1806, an identification of utilities in the plurality of utilities in which the advertisement will appear is received from the advertiser. At step 1808, the advertisement is inserted in the identified utilities. At step 1810, a selection of a trip item in a trip itinerary is received. At step 1812, a dedicated box associated with the trip item is generated. At step 1814, advertisements for services related to the trip item in the box are displayed.

An embodiment of the invention relates to a computer storage product with a computer-readable or machine-accessible medium having executable instructions or computer code thereon for performing various computer-implemented operations. The term “computer-readable medium” or “machine-accessible medium” is used herein to include any medium that is capable of storing or encoding a sequence of executable instructions or computer code for performing the operations described herein. The media and computer code can be those specially designed and constructed for the purposes of the invention, or can be of the kind well known and available to those having ordinary skill in the computer software arts.

Examples of computer-readable media include computer-readable storage media such as: magnetic media such as hard disks, floppy disks, and magnetic tape; optical media such as Compact Disc-Read Only Memories (“CD-ROMs”), DVDs, and holographic devices; magneto-optical media such as optical disks; and hardware devices that are specially configured to store and execute program code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as produced by a compiler, and files containing higher level code that are executed by a computer using an interpreter. For example, an embodiment of the invention may be implemented using Java, C++, or other programming language and development tools. Additional examples of computer code include encrypted code and compressed code. Another embodiment of the invention can be implemented in hard wired circuitry in place of, or in combination with, computer code.

In general, the routines, steps, and functional blocks executed to implement the embodiments of the disclosure and aforementioned features of the present invention may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit, and scope of the invention. All such modifications are intended to be within the scope of the claims appended hereto. In particular, while the methods disclosed herein have been described with reference to particular operations performed in a particular order, it will be understood that these operations may be combined, sub-divided, or reordered to form an equivalent method without departing from the teachings of the invention. Accordingly, unless specifically indicated herein, the order and grouping of the operations is not a limitation of the invention.

It is clear that many modifications and variations of this embodiment may be made by one skilled in the art without departing from the spirit of the novel art of this disclosure. These variations do not depart from the broader spirit and scope of the invention, and the examples cited here are to be regarded in an illustrative rather than a restrictive sense.

1. A computer implemented method for providing context-sensitive advertisements comprising:
providing, via a computing device, an advertiser access to a plurality of utilities that allow users to electronically manage trip items in a trip itinerary;
providing an interactive tool to allow the advertiser to create an advertisement related to the trip items;
receiving from the advertiser an identification of utilities in the plurality of utilities in which the advertisement will appear; and
inserting the advertisement in the identified utilities.

2. The method of claim 1 further comprising receiving an identification from the advertiser of particular screens of the identified utilities that are related to the advertisement.

3. The method of claim 2 further comprising selectively publishing the advertisement in the particular screens of the identified utilities that are related to the advertisement.

4. The method of claim 1 further comprising receiving identifying information regarding persons targeted by the advertisement.

5. The method of claim 4 further comprising receiving information regarding credit card usage of the persons.

6. The method of claim 4 further comprising receiving information regarding eligibility of the persons to use reward program credits.

7. The method of claim 1 further comprising providing detailed information about function of the plurality of utilities to the advertiser.

8. The method of claim 1 further comprising providing to the advertiser a preview of the advertisement before publication in the identified utilities.

9. The method of claim 1 further comprising providing the advertiser a preview of a advertisement within a utility.

10. The method of claim 1 further comprising receiving information about the format and size of the advertisement.

11. The method of claim 1 further comprising receiving at least one of title, copy, rate of service, display URL, and destination URL for the advertisement.

12. The method of claim 1 further comprising providing a sequence of a plurality of distinct stages that prompt the advertiser for information to complete the advertisement.

13. The method of claim 12 where each of the distinct stages corresponds to a unique interactive screen.

14. The method of claim 1 further comprising displaying the advertisement in the identified utilities upon selection by users of trip items related to the advertisement.

15. The method of claim 1 further comprising displaying the advertisement in the identified utilities adjacent to trip items related to the advertisement.

16. The method of claim 1 further comprising selectively displaying the advertisement in the identified utilities based on a selection by the user of a domain in the identified utilities.

17. The method of claim 1 further comprising:
displaying trip items in a trip itinerary;
listing adjacent the trip itinerary a plurality of advertisements for services related to the trip items; and
allowing a user to select a desired service by dragging and dropping from the plurality of advertisements an advertisement associated with the desired service into the trip itinerary.

18. The method of claim 1 further comprising:
receiving a selection of a trip item in a trip itinerary;
generating a dedicated box associated with the trip item; and
displaying advertisements for services related to the trip item in the box.

19. A tangible machine-readable medium having stored thereon a set of instructions, which when executed by a machine perform a method comprising:
providing an advertiser access to a plurality of utilities that allow users to electronically manage trip items in a trip itinerary;
providing an interactive tool to allow the advertiser to create an advertisement related to the trip items;
receiving from the advertiser an identification of utilities in the plurality of utilities in which the advertisement will appear; and
inserting the advertisement in the identified utilities.

20. A computer system comprising:
at least one server for:
providing an advertiser access to a plurality of utilities that allow users to electronically manage trip items in a trip itinerary;
providing an interactive tool to allow the advertiser to create an advertisement related to the trip items;
receiving from the advertiser an identification of utilities in the plurality of utilities in which the advertisement will appear; and
inserting the advertisement in the identified utilities.
